(19) United States
(12) Patent Application Publication
(10) Pub. No.: US 2013/0173398 A1
(43) Pub. Date: Jul. 4, 2013

(54) Search Engine Menu-based Advertising

(71) Applicants: Taifeng Wang, Beijing (CN); Tie-Yan Liu, Beijing (CN)

(72) Inventors: Taifeng Wang, Beijing (CN); Tie-Yan Liu, Beijing (CN)

(73) Assignee: MICROSOFT CORPORATION, Redmond, WA (US)

(21) Appl. No.: 13/340,195

(22) Filed: Dec. 29, 2011

(51) Int. Cl. G06Q 30/02

(52) U.S. Cl. 705/14.73

(57) ABSTRACT

Implementations for providing menu-based advertising are disclosed. A search engine front-end determines non-search engine information pages that are relevant to the user input based on user input entered into a search query field on a search page. A suggestion menu is caused to be displayed on a search page. The suggestion menu includes interactive elements that are interactive to cause a client device to retrieve the non-search engine information pages associated with the interactive elements. The interactive elements may be advertisements, and the suggestion menu may also be used to display search query suggestions.

### BACKGROUND

Search engine advertising involves displaying advertisements on search results pages. The user device displays advertisements along with search results, and users are able to select either an advertisement link or a search result link to cause their devices to retrieve information pages from the World Wide Web. Conventional search engines cause a separate search results page with the search results to be loaded onto the user's device, while some modern search engine interfaces display search results and advertisements as the user enters his or her search query without loading a separate results page. But in either case, both the advertisements and the search results are selected for display based on search queries entered by the users in a search engine page through a web browser, or other interface. The search results are produced by a search engine, and are typically based in part on various search algorithms whose purpose is to select web pages that are relevant to the user's search query. Advertisements, on the other hand, are selected in part based on bids that advertisers make for particular keywords in the user's search query.

Another aspect of modern search engine interfaces is the inclusion of a search query suggestion feature. As the user types his or her search query, a drop-down menu appears showing suggested search queries. These suggested search queries are typically selectable by the user to form a complete search query.

### BRIEF SUMMARY

This Summary is provided in order to introduce simplified concepts of search engine menu-based advertising, which are further described below in the Detailed Description. This summary is not intended to identify essential features of the claimed subject matter, nor is it intended for use in determining the scope of the claimed subject matter.

A search engine front-end determines one or more non-search engine information pages that are relevant to user input entered into a search query field of a search page. The search engine front-end causes a client device to display a suggestion menu on the search page that includes one or more search query suggestions as well as interactive elements that are selectable to cause the client device to retrieve the non-search engine information pages. The non-search engine information pages may be advertisements.

The non-search engine information pages displayed within the suggestion menu are from authoritative advertisers. An authoritative advertiser is determined based on authoritative information for the advertisers. Such authoritative information may include social networking metrics, page rank data, click-through effectiveness data, or other. Also, the search engine front-end may cause the same or different authoritative information to be displayed on the search page, such as within the suggestion menu or in a pop-up window or overlay user interface element.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 is a schematic diagram of an example system usable to provide menu-based search engine advertising.

FIG. 2 is a block diagram of an example computing system usable to provide menu-based advertising according to embodiments.

FIG. 3 is a flow diagram showing an example process for menu-based search engine advertising.

FIG. 4 shows an example search query page having a menu-based advertisement.

FIG. 5 shows an example search query page having menu-based advertisements and authoritativeness information displayed as part of an overlay user interface element.

### DETAILED DESCRIPTION

### Overview

As discussed above, conventional search engine advertising displays advertisements next to search results. Even though many advertisements include content that would be useful to users, some users tend to ignore the advertisements. The reasons for this vary, but some users cite unreliable quality of the information provided by advertisements as one concern. Users also cite uncertainty regarding the trustworthiness and the authoritativeness of the advertisers themselves. In short, some users have difficulty distinguishing between useful and uninteresting advertisements, and difficulty telling which advertisements are from trustworthy and authoritative sources.

Embodiments of the present Detailed Description include a search engine front-end that causes advertisements to be displayed as part of suggestion menus. The advertisements are shown in the suggestion menu as the user types his or her search query into a search query field of a search engine page. In embodiments, the suggestion menu also includes search query suggestions that are based on the entered user input. Authoritativeness information—such as popularity information from social networking services, search engine statistics, or other sources—are displayed along with the advertisements to provide the user with a sense of the authoritativeness of the advertiser.

In embodiments, the advertisements placed in the suggestion menu may be from a select group of advertisers. The advertisers in this group may be selected based on the relative authoritativeness of the advertisers. In embodiments, search engine results, page ranks, click-through rates, or other data may be used to determine those advertisers that meet a minimum level of authoritativeness. In embodiments, display of advertisements in a suggestion menu is closed to non-authoritative advertisers. The advertisements displayed in a suggestion menu are selected from a pool of advertisements from the authoritative advertisers based on the user's search query, such as for example based on bids placed by the advertisers for keywords used in the search query.

Users tend to pay attention to search query suggestion menus. Thus, users are more likely to pay attention to advertisements in search query suggestions menus than they are to pay attention to advertisements on the search results pages. Also, by interacting with suggestion menus according to embodiments, users can learn to expect relatively higher quality advertisements from the most authoritative advertisers to appear in the suggestion menu. This user expectation for quality and authoritativeness results in a premium advertising space for search engines.

The processes, systems, and devices described herein may be implemented in a number of ways. Example implementations are provided below with reference to the following figures.

### Example Environment for Menu-Based Search Engine Advertising

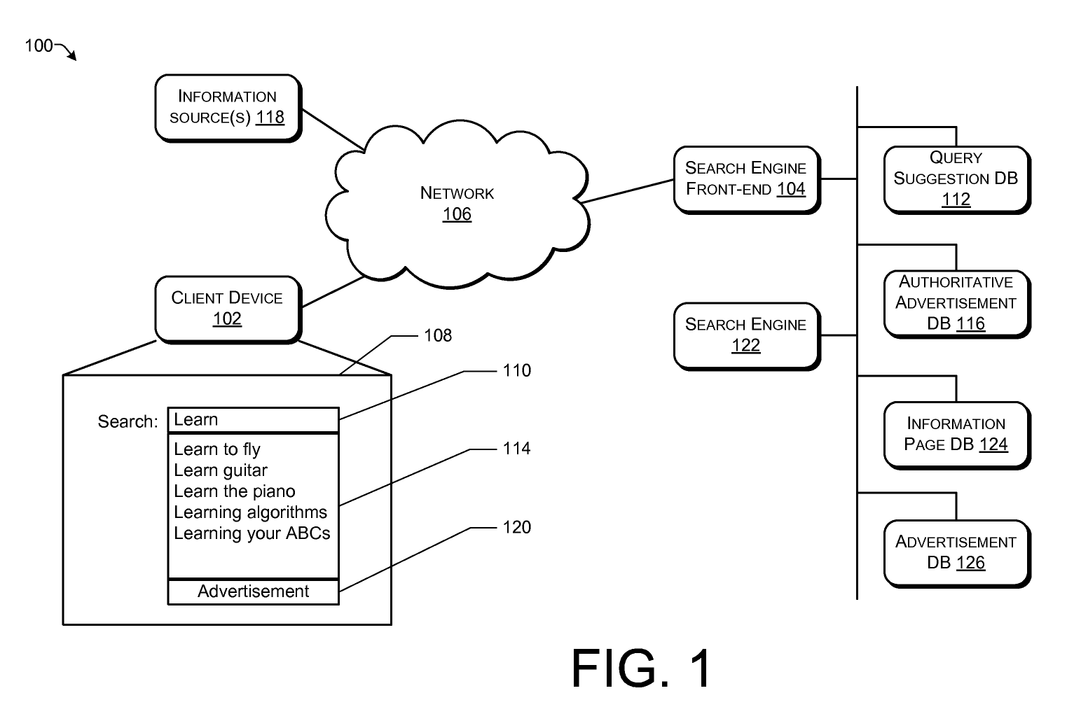

FIG. 1 is a schematic diagram of an example system 100 usable to provide menu-based search engine advertising. Aspects of the system 100 may be implemented on various suitable computing device types that are capable of implementing a search engine front-end, a search engine, and/or a client device. Suitable computing device or devices may include, or be part of, one or more personal computers, servers, server farms, datacenters, special purpose computers, tablet computers, game consoles, smartphones, combinations of these, or any other computing device(s) capable of storing and executing all or part of a menu-based search engine advertising system.

A client device 102 is communicatively coupled to search engine front-end 104 via a network 106. The network 106 may include various network topologies, and may include or be part of the public Internet. The network 106 may also include a wireless portion. For example, the client device 102 may be wirelessly coupled to the network 106. Embodiments are not limited to any particular wired or wireless networking topologies, technologies, or protocols.

The search engine front-end 104 may be a web server, configured to serve web pages formatted at least in part with hypertext markup language (HTML) or other formatting type. The client device 102 may include a web browser application for retrieving and viewing web pages. The client device 102 may also include a display device, and the client device may be configured to display a search engine query page 108 retrieved from the search engine front-end 104. The search engine query page 108 includes a search query field 110, usable by a user of client device 102 to input text. This input text forms all or part of a search query. In various embodiments, voice recognition may be employed by the client device 102 and or search engine front-end 104 to generate the text input for search query field 110.

Client device 102 transmits the input text to the search engine front-end 104. The search engine front-end 104 performs a look-up to a query suggestion database 112 for suggested search queries. This look-up is based on the text input into the search query field 110. The suggested search queries may be based on popular search queries that share similarities with the entered text. In embodiments, the suggested search queries may include the entered text plus additional keywords. In embodiments, the suggested search queries may include suggested search queries with corrected spelling, search queries that are synonyms of the entered text, and/or other related search queries.

The search engine front-end 104 provides the client device 102 with the suggested search queries, and causes the client device 102 to display the suggested queries in suggestion menu 114. As shown in FIG. 1, the suggestion menu 114 is situated below the search query field 110, but embodiments are not limited to this placement.

The search engine front-end 104 also performs a look-up to an authoritative advertisement database 116. Authoritative advertisement database 116 includes a plurality of advertisements from authoritative advertisers. The look-up to the authoritative advertisement database 116 returns one or more advertisements from the authoritative advertisement database 116 that are related to the text entered into the search query field 110. In a non-limiting example, the advertisements returned may be based on bids placed by the advertisers for keywords. Thus, the advertisements returned may be those advertisements with the highest bid scores for one or more keywords in the text entered into the search query field 110.

The search engine front-end 104 provides the client device 102 with, and causes the client device 102 to display, interactive elements related to the advertisements returned from the look-up to the authoritative advertisement database 116. The interactive elements may be graphical icons or other interactive elements that are user selectable to cause the client device 102 to retrieve non-search engine information pages. The non-search engine information pages are retrievable from the information source(s) 118 via the network 106.

The client device 102 is configured to display the one or more interactive elements within suggestion menu 114, such as in the bottom portion 120 (although other placements within suggestion menu 114 are possible without departing from the scope of the present Detailed Description). Also authoritativeness information may be displayed next to the interactive elements to give the user a sense of the authoritativeness of the advertiser associated with the interactive element. The authoritativeness information may include social networking mentions or “likes,” page rank information, or other. The authoritativeness information may be displayed next to the interactive element, and may be displayed upon a first type of user interaction with the interactive element, such as a hover over the interactive element, a right-click plus menu selection, or other interaction. Upon the user selecting an interactive element from the suggestion menu 114 by a second type of interaction (such as by left-clicking on the interactive element, tapping or gesturing on the interactive element via a touch-sensitive screen, or other), the client device 102 retrieves the corresponding non-search engine information page from the information source(s) 118.

Upon the user either selecting one of the suggested search queries in suggestion menu 114, or upon the user completing a search query without selecting one of the suggested search queries, the search engine front-end 104 provides the completed search query to a search engine 122. The search engine 122 employs various search algorithms to search the information page database 124 and to return search results that are relevant to the search query. The search engine 122 (or the search engine front-end 104) may be configured to search one or both of authoritative advertisement database 116 and advertisement database 126 for one or more advertisements that are related to the search query. Such advertisements may be based on keyword bids as are discussed elsewhere within this Detailed Description.

The search engine front-end 104 is configured to return the search results and the advertisements to the client device 102 and to cause the client device 102 to display a search results page that includes the search results and the advertisements. The search results page may be similar to a conventional search results page, except that the search results page may also include a suggestion menu similar to suggestion menu 114 based on further user input entered into a search query field of the search results page. The suggestion menu 114 may include advertisements from authoritative advertisement database 116, but not advertisements from the advertisement database 126. Thus, the suggestion menu 114 may in embodiments be a premium, or special advertising channel that includes advertisements only from the most authoritative advertisers.

### Example Computing Device for a Menu-Based Search Engine Advertising

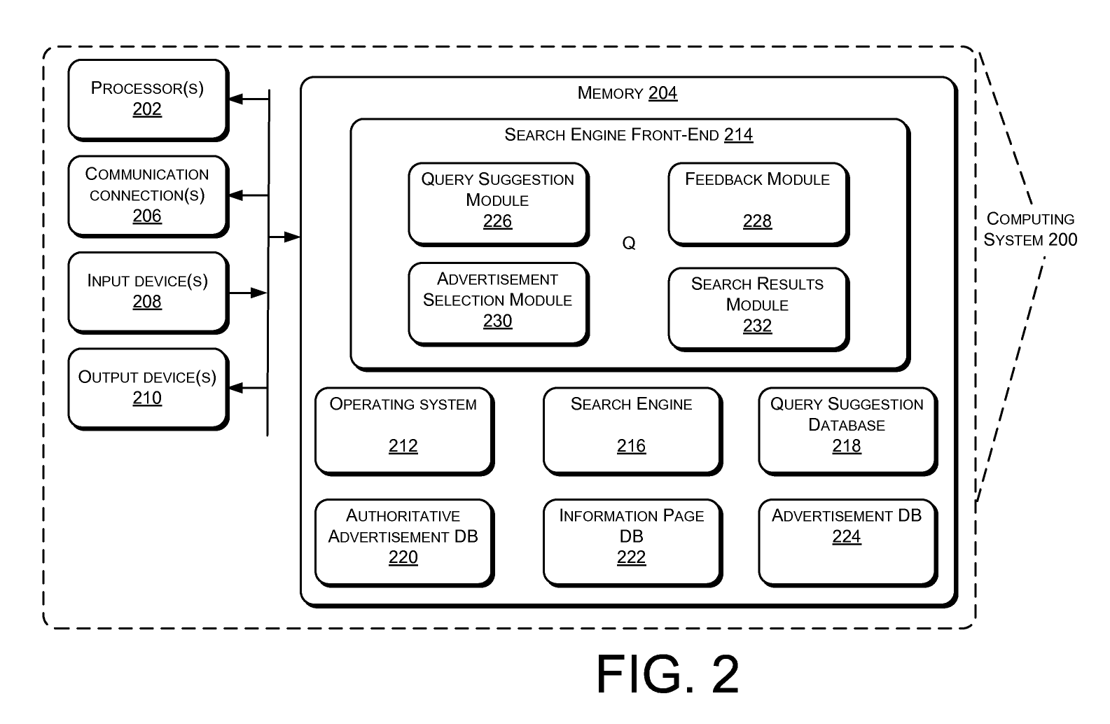

FIG. 2 is a block diagram of an example computing system usable to provide menu-based advertising according to embodiments. The computing system 200 may be configured as any suitable computing device capable of implementing menu-based advertising. According to various non-limiting examples, suitable computing devices may include personal computers (PCs), servers, server farms, datacenters, special purpose computers, tablet computers, game consoles, smartphones, combinations of these, or any other computing device(s) capable of storing and executing all or part of menu-based advertising.

In one example configuration, the computing system 200 comprises one or more processors 202 and memory 204. The computing system 200 may also contain communication connection(s) 206 that allow communications with various other systems. The computing system 200 may also include one or more input devices 208, such as a keyboard, mouse, pen, voice input device, touch input device, etc., and one or more output devices 210, such as a display, speakers, printer, etc. coupled communicatively to the processor(s) 202 and memory 204.

Memory 204 may store program instructions that are loadable and executable on the processor(s) 202, as well as data generated during execution of, and/or usable in conjunction with, these programs. In the illustrated example, memory 204 stores an operating system 212, which provides basic system functionality of the computing system 200 and, among other things, provides for operation of the other programs and modules of the computing system 200.

Memory 204 includes a search engine front-end 214, which may be the same as or similar to search engine front-end 104. Memory 204 includes a search engine 216, which may be the same as or similar to search engine 122. Memory 204 includes a query suggestion database 218, an authoritative advertisement database 220, an information page database 222, and an advertisement database 224, which may be the same as or similar to the query suggestion database 112, the authoritative advertisement database 116, the information page database 124, and the advertisement database 126, respectively. Also, one or more of these databases could be combined or split up without departing from the scope of the present disclosure.

The search engine front-end 214 includes a query suggestion module 226 that is configured to provide one or more search query suggestions based on user input entered into a search query field of a client device and received by the search engine front-end 214. The query suggestion module 226 performs a look-up operation to the query suggestion database 218 to retrieve the query suggestions.

The search engine front-end 214 includes a feedback module 228 configured to cause display of a suggestion menu, such as a drop-down menu, on the client device. The suggestion menu includes a first portion for the one or more search query suggestions and a second portion for one or more advertisements. The advertisements may include interactive elements that are selectable to cause the client device to retrieve a non-search engine information page that is relevant to the user input. The interactive elements may be graphical elements or icons displayed within the suggestion menu, and the non-search engine information pages may include textual, graphical, video, and/or audio content related to the advertisement.

The feedback module 228 is configured to cause the client device to display the advertisement along with an associated authoritativeness indicator within the second portion of the drop-down menu. The authoritativeness indicator includes authoritativeness information related to either the advertisement or the advertiser associated with the advertisement. The authoritativeness information may include social networking data (such as social networking “likes” or mentions), page rank information, click-through data from the same or other advertisements of the advertiser, metrics combining one or more of social networking, page rank, or click-through data, and so forth.

The search engine front-end 214 includes an advertisement selection module 230 configured to select the advertisements for display within the suggestion menu. The advertisement selection module 230 performs look-up operations to the authoritative advertisement database 220 to retrieve one or more advertisements that are related to the user query. The authoritative advertisement database 220 may also include authoritativeness information associated with the advertisements. Such authoritativeness information may be retrieved periodically from one or more sources, such as social networking sites, page rank indices, search engine data, or other sources. In one non-limiting example, the one or more advertisements may be selected based on bid scores associated with one or more keywords of the user's search query. The second portion of the suggestion menu displayed by the client device may be reserved for advertisements from a subset of a plurality of advertisers that have associated authoritativeness metrics that at least equal a predetermined threshold. Thus, the advertisements included in the authoritative advertisement database 220 include those advertisements that meet the predetermined threshold. The predetermined threshold may be a threshold number of social networking mentions or “likes,” a threshold page rank, a threshold click-through effectiveness ranking, a combination metric, or other data.

Although various embodiments described herein are configured to cause display of authoritative advertisements within the suggestion menu, and to display authoritativeness information associated with the advertisement or advertiser, embodiments of the Detailed Description may do none or both of these things. For example, embodiments may display advertisements in the suggestion menu that do not meet predetermined threshold authoritativeness metrics. And the same or other embodiments may display advertisements without also displaying authoritativeness metrics.

The search engine front-end 214 includes a search results module 232 configured to cause the client device to display a search results page that includes one or more search results plus one or more other interactive elements interactive to cause the client device to retrieve corresponding one or more other non-search engine information pages for display. The interactive elements may be advertisements, such as advertisements from one or both of authoritative advertisement database 220 and advertisement database 224. The non-search engine information pages include advertising or other information provided by an advertiser.

The computing system 200 is therefore configured to cause display of advertisements on a client device. Advertisements from advertisers that meet a threshold level of authoritativeness—such as is defined by popularity metrics such as social networking mentions, page ranks, click-through effectiveness or other data—are displayed in a suggestion menu on the search engine query page, such as a home page or “page zero” of the search engine front-end 214. The computing system 200 is also configured to cause display of advertisements from a larger pool of advertisements, such as advertisements from both the authoritative advertisement database 220 and the advertisement database 224, on a search results page provided by the search engine front-end 214.

Placement of advertisements into the authoritative advertisement database 220 may be performed by a manual process of reviewing the authoritativeness information associated with the advertisers. Alternatively, advertisements may be placed into the database based on automated mining of social networking, page rank, or other data followed by automated placement (or removal) of advertisers' advertisements into the database based on an automated determination that the advertisers meet (or fail to meet) a predetermined level of authoritativeness.

A search results page served to the client device by the computing system 200 may also have a search query field for entering a refined or new search query. The search engine front-end 214 is, in various embodiments, configured to provide a suggestion menu associated with queries entered into the search query field on the search results page in a same or similar manner as the suggestion menu is provided on the home page or “page zero” of the search engine front-end 214. The query suggestion module 226 is configured to provide search query suggestions based on the refined or new search query, and the advertisement selection module 230 is configured to provide advertisements from the authoritative advertisement database 220 based on the refined or new search query.

### Example Operations for Menu-Based Search Engine Advertising

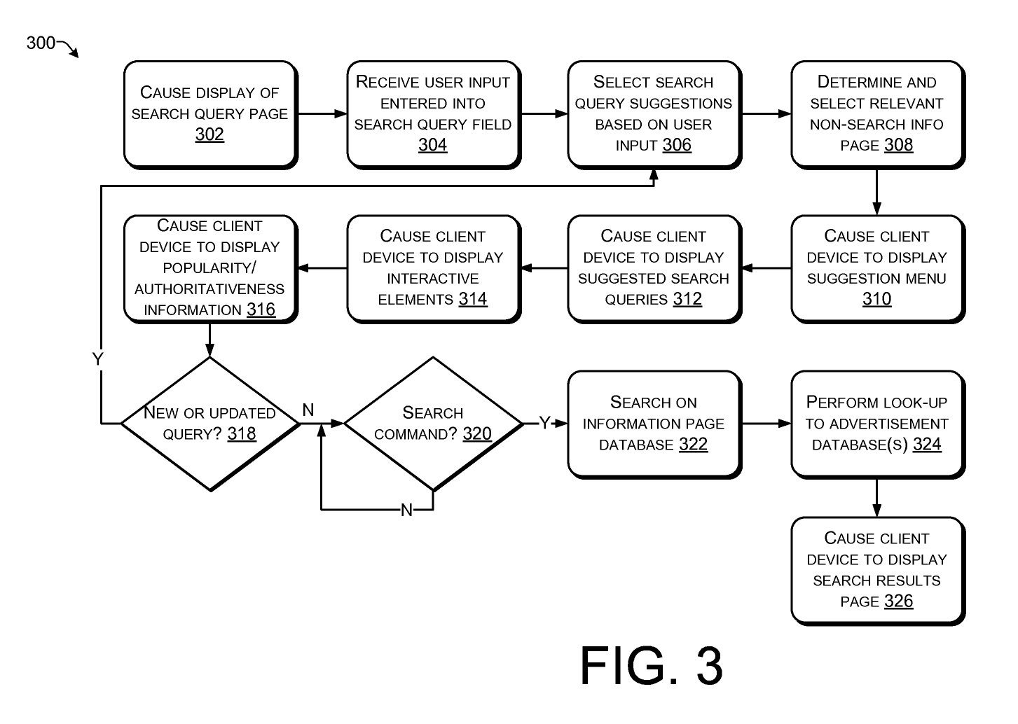

FIG. 3 is a flow diagram showing an example process 300 for menu-based search engine advertising. At 302, a search engine front-end, such as the search engine front-end 104 or 214, causes a client device to display a search query page having a search query field. The search query page may be a home page, or a “page zero” of the search engine front-end. Alternatively, the search query page may be some other page, such as a search results page from a previously executed search, where the search results page includes a search query field for refining the previously submitted search query or entering a new search query.

At 304, the search engine front-end receives user input entered into the search query field of a search page displayed on a client device. The user input may be a partial or complete search query. But at 304 the user has not necessarily provided input indicating a command to execute a search on the search query. Instead, the search query page is configured to send the user input to the search engine front-end prior to the user selecting a function to execute a search.

At 306, a search query suggestion module, such as the query suggestion module 226, performs a look-up to a query suggestion database to select one or more search query suggestions based on the received user input. The suggested search queries may be search queries that include the user-entered text plus additional keywords. Other suggested search queries may be synonyms for the entered text, queries with corrected spelling, and so forth.

At 308, an advertisement selection module, such as the advertisement selection module 230, performs a look-up to an authoritative advertisement database to determine and select a non-search engine information page that is relevant to the user input. The non-search engine information page may be an advertisement. The non-search engine information page is selected, in embodiments, from a plurality of information pages of a first subset of a plurality of information sources (i.e., advertisers). The first subset of the plurality of information sources have corresponding authoritativeness metrics that indicate greater authoritativeness than do corresponding authoritativeness metrics of individual ones of a second subset of the plurality of information sources (such as in the advertising database 224). The authoritativeness metrics may be popularity metrics, such as social networking data, page rank data, search engine data (such as click-through effectiveness data), and so forth.

At 310, the search engine front-end causes the client device to display a suggestion menu on the search query page. The suggestion menu may include a drop-down menu, or some other menu type. In various embodiments, the suggestion menu may be placed next to the search query field, may be in a pop-up window, may be part of a user interface element that overlays a portion of the search query page, and so forth.

At 312, the search engine front-end causes the client device to display the suggested search queries within a portion of the suggestion menu. The query suggestions may be selectable to cause the text entered into the search query field to be replaced with or augmented by the selected search query suggestion.

At 314, the search engine front-end causes the client device to display interactive elements associated with the selected advertisements from the authoritative advertisement database. The display of the interactive elements is concurrent with the display of the search query suggestions. The interactive elements are selectable to cause the client device to retrieve associated non-search engine information pages for display on the client device. The interactive elements may be advertisements, and selecting them within the suggestion menu may cause the client device to retrieve and display a non-search information page with marketing, advertising, informational, or other content from a non-search engine source. The advertisement may have graphical elements, text, animation, and/or video, and may indicate the name of the advertiser associated with the advertisement.

At 316, the search engine front-end is configured to cause the client device to display authoritativeness information (such as popularity information). The authoritativeness information is associated with the advertiser associated with an advertisement displayed in the suggestion menu. The authoritativeness information may be displayed within the suggestion menu, such as next to the advertisement, or displayed in a separate element such as a user interface element that overlays a portion of the search query page. The authoritativeness information may be displayed upon user interaction with the interactive element, such as by a pointing device, a pointer hover over the interactive element, a click (such as a right-click along with menu selection) on the interactive element, a finger tap or gesture on the interactive element displayed on a touch screen, or other interaction. Alternatively, the authoritativeness information may be displayed without further user input. The authoritativeness information may be popularity information, such as social networking mentions or “likes,” click-through effectiveness data, page rank data, or other popularity data that serves as a proxy for the authoritativeness of the advertiser or advertisement.

At 318, a determination is made regarding whether additional user input is received forming a new or updated query. Such additional user input could be newly entered text, selection of a suggested query, voice or other input modifying the original input, and so forth. If the additional user input is received, then various portions of the process 300 are repeated, such as performing a look-up to a query suggestion database at 306, performing a look-up to the authoritative advertisement database at 308, and so forth. The search engine front-end causes replacement of the interactive elements, query suggestions, and authoritativeness information within the suggestion menu with other interactive elements associated with the other non-search information page, other search query suggestions, and/or other authoritativeness information.

At 320, a determination is made regarding whether user input indicating a command to execute a search on a search query is received. The command input may include a click on a button or other icon on the search query page indicating that the search query is complete and that a search should be performed. The command input may alternatively include voice command or other.

At 322, a search engine, such as search engine 216, performs a search on an information page database for search results that are relevant to the search query. Various conventional or non-conventional search algorithms may be employed to perform the search.

At 324, the search engine front-end may perform a look-up to the authoritative advertisement database and/or the advertisement database to determine one or more advertisements related to the search query. For example, advertisements may be selected based on advertisers' bid scores for the keywords included within the search query.

At 326, the search engine front-end causes the client device to display a search results page that includes one or more search results plus one or more other interactive elements, such as advertisements, that are interactive to cause the client device to retrieve corresponding non-search engine information pages for display on the client device. The other non-search engine information pages may include at least one information page that is not included in the authoritative advertisement database.

FIG. 3 depicts a flow graph that shows an example process in accordance with various embodiments. The operations of this process is illustrated in individual blocks and summarized with reference to those blocks. The process is illustrated as a logical flow graph, each operation of which may represent a set of operations that can be implemented in hardware, software, or a combination thereof. In the context of software, the operations represent computer-executable instructions stored on one or more computer storage media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be combined in any order, separated into sub-operations, and/or performed in parallel to implement the process. Processes according to various embodiments of the present disclosure may include only some or all of the operations depicted in the logical flow graph.

Example Search Query Pages with Menu-Based Advertisement

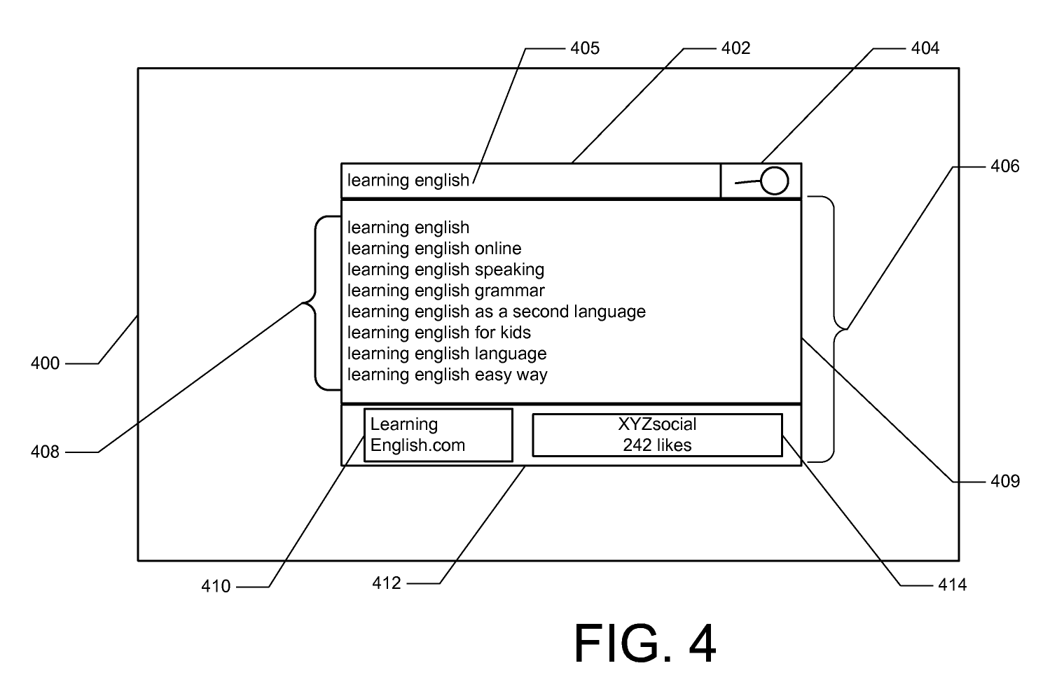

FIG. 4 shows an example search query page 400 having a menu-based advertisement. The search query page 400 is displayed on a client device and includes a search query field 402 and a search command button 404. Upon user input 405 into the search query field 402—such as the non-limiting example user input “learning english” shown in FIG. 4—the client device is configured to transmit the user input 405 to a search engine front-end (such as the search engine front-end 104 or the search engine front-end 214). The client device receives instructions from the search engine front-end to display suggestion menu 406. As shown in FIG. 4, the suggestion menu 406 is situated directly below the search query field 402, but other placements are possible without departing from the scope of this Detailed Description.

The client device also receives instructions to display one or more search query suggestions 408 within a first portion 409 of the suggestion menu 406. The client device also receives instructions to display an interactive element 410 within a second portion 412 of the suggestion menu 406. The interactive element 410 is representative of an advertisement, and is selectable to cause the client device to retrieve and display a non-search engine information page associated with the interactive element 410. The second portion 412 is shown at the bottom of the suggestion menu 406, but embodiments are not limited to this particular placement.

The search query page 400 also includes authoritativeness information 414. In the example shown in FIG. 4, the authoritativeness information 414 shows 242 “likes” on social networking service XYZsocial. Other types of authoritativeness information can be included as is described elsewhere within this Detailed Description.

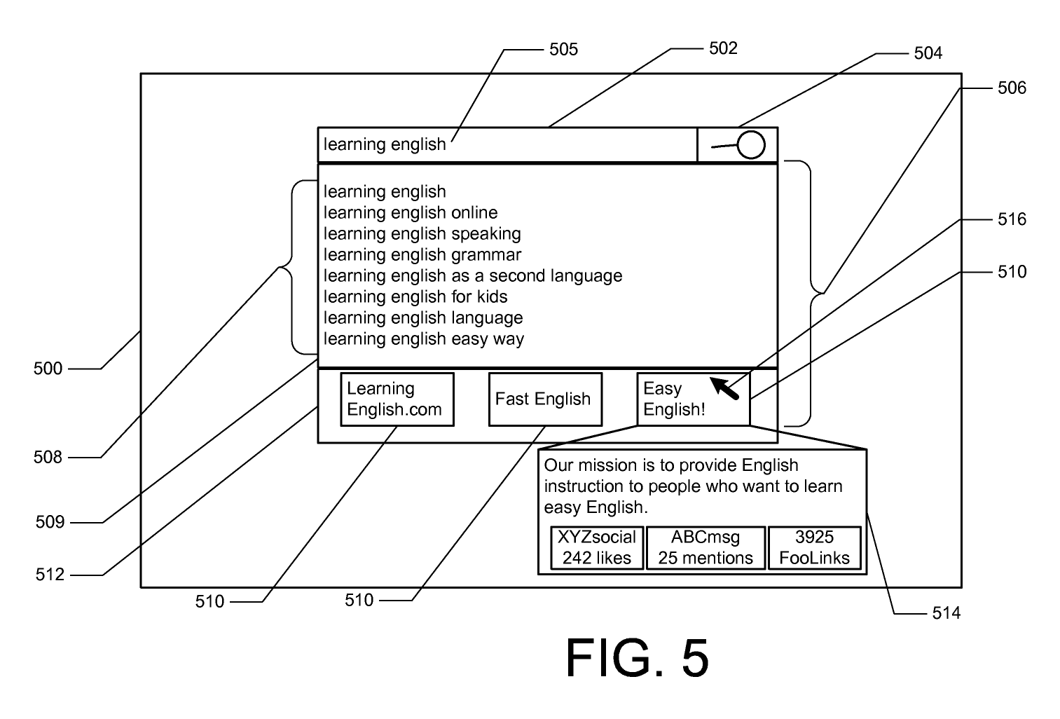

FIG. 5 shows an example search query page 500 having menu-based advertisements and authoritativeness information displayed as part of an overlay user interface element. The search query page 500 includes a search query field 502, a search command button 504, user input 505, a suggestion menu 506, and one or more search query suggestions 508, which may be the same as or similar to the search query field 402, the search command button 404, the user input 405, the suggestion menu 406, and the one or more search query suggestions 408, respectively. The one or more search query suggestions are within a first portion 509 of the suggestion menu 506. The search query page 500 also includes interactive elements 510 within a second portion 512 of the suggestion menu 506. The interactive elements 510 are representative of advertisements, and are selectable to cause the client device to retrieve and display non-search engine information pages associated with the interactive elements 510. The second portion 512 is shown at the bottom of suggestion menu 506, but embodiments are not limited to this particular placement.

Search query page 500 also includes authoritativeness information 514. The authoritativeness information 514 is included in a pop-up window or overlay user interface element. The authoritativeness information 514 is associated with a particular one of interactive elements 510, and may be shown based on a user interaction with the particular one of the interactive elements 510, such as a pointer 516 hover of the interactive element, or some other interaction. Other authoritativeness information may be shown upon user interaction with other ones of the interactive elements 510. In the example shown in FIG. 5, the authoritativeness information includes general information about the advertiser “Easy English!” and indicates that there are 242 “likes” for “Easy English” on social networking service XYZsocial, 25 mentions on ABCmsg, and 3925 links on FooLink. Other types of authoritativeness information can be included as is described elsewhere within this Detailed Description.

FIGS. 4 and 5 illustrate various search query pages. These search query pages are presented for the sake of illustration, and their exact layouts and contents are not to be taken as limitations. Alternative layouts and contents can be used without departing from the scope of this Detailed Description.

### Computer-Readable Media

Depending on the configuration and type of computing device used, memory 204 of the computing system 200 in FIG. 2 may include volatile memory (such as random access memory (RAM)) and/or non-volatile memory (such as read-only memory (ROM), flash memory, etc.). Memory 204 may also include additional removable storage and/or non-removable storage including, but not limited to, flash memory, magnetic storage, optical storage, and/or tape storage that may provide non-volatile storage of computer-readable instructions, data structures, program modules, and other data for computing system 200.

Memory 204 is an example of computer-readable media. Computer-readable media includes at least two types of computer-readable media, namely computer storage media and communications media.

Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer-readable instructions, data structures, program modules, or other data in a modulated data signal, such as a carrier wave, or other transmission mechanism. As defined herein, computer storage media does not include communication media.

### Conclusion

Although the disclosure uses language that is specific to structural features and/or methodological acts, the invention is not limited to the specific features or acts described. Rather, the specific features and acts are disclosed as illustrative forms of implementing the invention.

What is claimed is:

1. A method, comprising:
receiving user input entered into a search query field of a search page displayed on a client device;
determining a non-search engine information page that is relevant to the user input; and
causing, responsive to the user input, a suggestion menu to be displayed on the search page, the suggestion menu including an interactive element that is user-interactive to cause the client device to retrieve the non-search engine information page for display on the client device.

2. The method of claim 1, wherein the interactive element is an advertisement.

3. The method of claim 1, further comprising causing display within suggestion menu of popularity information associated with the non-search engine information page.

4. The method of claim 1, further comprising causing display of popularity information associated with the non-search engine information page responsive to user interaction with the interactive element.

5. The method of claim 1, further comprising causing, concurrently with the display of the interactive element, display within the suggestion menu of one or more suggested search queries corresponding to the user input.

6. The method of claim 1, wherein the determining further comprises selecting the non-search engine information page only from a plurality of information pages of a first subset of a plurality of information sources, wherein corresponding authoritativeness metrics of individual ones the first subset of the plurality of information sources indicate greater authoritativeness than do corresponding authoritativeness metrics of individual ones of a second subset of the plurality of information sources.

7. The method of claim 6, wherein the authoritativeness metrics of the plurality of information sources are popularity metrics.

8. The method of claim 6, further comprising:
receiving further user input to execute a search based on a search query; and
causing display of a search results page that includes one or more search results plus one or more other interactive elements interactive to cause the client device to retrieve corresponding one or more other non-search engine information pages for display on the client device, wherein the one or more other non-search engine information pages include at least one information page from the other ones of the plurality of information sources.

9. A system for displaying advertisements on a client device, the system comprising:
memory;
one or more processors
a query suggestion module stored on the memory and executable by the one or more processors to provide one or more search query suggestions based on user input entered into a search query field of a client device and a look-up to a query suggestion database;
an advertisement selection module stored on the memory and executable by the one or more processors to select, responsive to the user input, an advertisement selectable to cause the client device to retrieve a non-search engine information page that is relevant to the user input; and
a feedback module stored on the memory and executable by the one or more processors to cause display of a suggestion menu on the client device, a first portion of the suggestion menu including the one or more search query suggestions and a second portion of the suggestion menu including the advertisement.

10. The system of claim 9, wherein the advertisement selection module is further executable to select the advertisement from a plurality of advertisements, the plurality of advertisements from a plurality of authoritative advertisers that have been selected from amongst a larger plurality of advertisers based on corresponding authoritativeness metrics of individual ones of the larger plurality of advertisers.

11. The system of claim 10, wherein the corresponding authoritativeness metrics of the advertisers are based on social networking popularity information or page rank information of the individual ones the larger plurality of advertisers.

12. The system of claim 9, wherein the feedback module is further configured to cause display of the advertisement and an associated authoritativeness indicator within the second portion of the suggestion menu, the authoritativeness indicator indicating an authoritativeness of an advertiser associated with the advertisement.

13. The system of claim 9, wherein the second portion is reserved for advertisements from a subset of a plurality of advertisers, the subset having associated authoritativeness metrics that at least equal a predetermined threshold.

14. Computer-readable storage media comprising a plurality of programming instructions that are executable by one or more processors of a computing system to cause the computing system to:
select one or more search query suggestions based at least in part on user input entered into a search query field in a search engine home page displayed on a client device;
determine a non-search information page that is relevant to the user input; and
cause display, on the search engine home page on the client device, of a suggestion menu that includes the one or more search query suggestions and an interactive element that is selectable to cause the client device to retrieve the non-search information page.

15. The computer-readable storage media of claim 14, wherein the interactive element is an advertisement indicating an advertiser associated with the non-search information page.

16. The computer-readable storage media of claim 14, wherein the plurality of programming instructions are further executable by the one or more processors to cause the computing system to cause the client device to display popularity information associated with an information source associated with the non-search information page.

17. The computer-readable storage media of claim 16, wherein the plurality of programming instructions are further executable by the one or more processors to cause the computing system to cause the client device to display the popularity information within the suggestion menu.

18. The computer-readable storage media of claim 16, wherein the plurality of programming instructions are further executable by the one or more processors to cause the computing system to cause the client device to display the popularity information in an element separate from the suggestion menu.

19. The computer-readable storage media of claim 16, wherein the plurality of programming instructions are further executable by the one or more processors to cause the computing system to select the non-search information page from a plurality of non-search information pages associated with a plurality of authoritative information sources.

20. The computer-readable storage media of claim 14, wherein the plurality of programming instructions are further executable by the one or more processors to cause the computing system to:
select another non-search information page that is relevant to additional user input entered into the search query field; and
cause replacement of the interactive element within the suggestion menu with another interactive element associated with the other non-search information page.
